(19) United States
(12) Patent Application Publication
(10) Pub. No.: US 2009/0145991 A1
(43) Pub. Date: Jun. 11, 2009

(54) Cutter Wheel for Granulating Strands of Plastic Material

(75) Inventor: Peter Meister, Aschaffenburg (DE)

Correspondence Address: BIRCH STEWART KOLASCH & BIRCH, PO BOX 747, FALLS CHURCH, VA, 22040-0747, US

(73) Assignee: Rieter Automatik GmbH, Grobostheim (DE)

(21) Appl. No.: 12/225,887

(22) PCT Filed: Apr. 3, 2007
(86) PCT No.: PCT/EP2007/003003

§ 371 Date: Nov. 12, 2008

(30) Foreign Application Priority Data
Apr. 20, 2006 (DE) 102006018375.4

(51) Int. Cl. B02C 18/06

(52) U.S. Cl. 241/295; 241/291

(57) ABSTRACT

The invention relates to a cutter wheel for granulating strands of plastic material, said cutter wheel being composed of a plurality of jointlessly juxtaposed wheel portions with individual cutter portions and having axially extending teeth, said teeth forming a continuous cutting edge. The teeth of the cutter portions merge into each other and have such an alternating inclination with respect to the axis of the cutter wheel that there result continuously extending zigzag-shaped cutting edges over the entire cutter wheel.

The invention relates to a cutter wheel for granulating strands of plastic material, said cutter wheel being composed of a plurality of jointlessly juxtaposed wheel portions with individual cutter portions and having axially extending teeth, said teeth forming a continuous cutting edge.

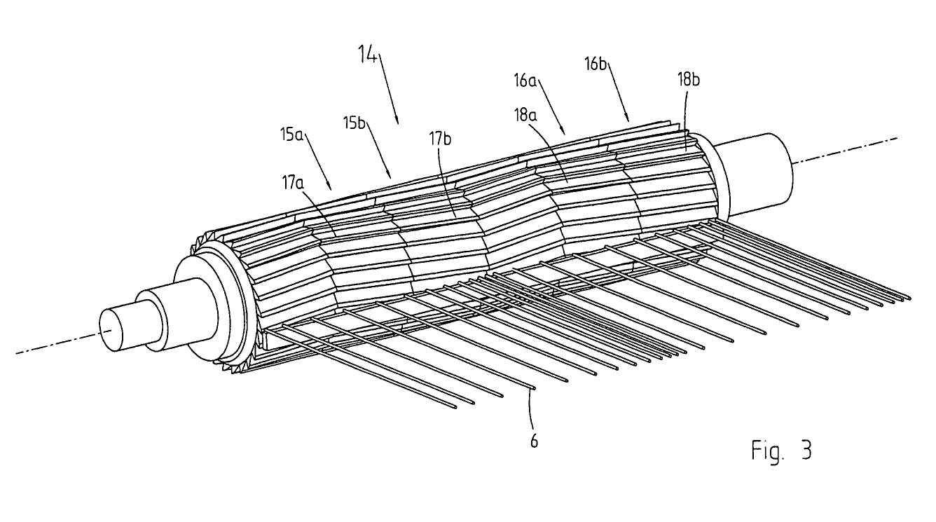

Such a cutter wheel is presented in FIG. 3 of DE-AS 1 266 114 and is briefly explained in the description. The reason given for dividing the cutter wheel into juxtaposed wheel portions is that this makes it possible to offset the cutters relative to each other from one wheel portion to the next, so that the teeth extend in staggered manner, this resulting in a distribution of the cutting edges. Thus, the cutter portions of the individual wheel portions do not cut simultaneously, but in consecutively staggered manner.

Such consecutive cutting along a cutter portion results, from one wheel portion to the next, in an abrupt loading of the cutter wheel, this having an adverse effect on the desired smooth running thereof. Therefore, another design of cutter wheel has become known in which axially continuous cutters are disposed at a slight slope, this providing the cutters with a certain inclination in relation to a necessary counter-cutter. The consequence thereof is that, when the cutters are cutting strands of plastic material being supplied via the counter-cutter, said strands of plastic material are subjected, during delivery, to an axially extending displacement force, this leading, especially where a multiplicity of closely juxtaposed strands are being supplied, to a crowding-together of the strands on one side of the cutter wheel, as a consequence whereof the cutters on that side are subjected to correspondingly higher loading than on the other side. This results along the cutters in uneven wear, this then necessitating the correspondingly premature replacement of the cutter wheel by a new sharp cutter wheel.

The object of the invention is to design the initially described cutter wheel such that it is subject to uniform wear along the cutter wheel. The object of the invention is achieved in that the teeth of the cutter portions merge into each other and have such an alternating inclination with respect to the axis of the cutter wheel that there result continuously extending zigzag-shaped cutting edges over the entire cutter wheel.

Because of the zigzag shape of each cutting edge, the strands of plastic material supplied to the cutter wheel are subjected, in each wheel portion, to a small displacement force alternately in one axial direction and in the opposite axial direction, the strands being able to be supported against each other laterally in groups on the counter-cutter, with the result that, viewed over the entire cutter wheel, there is virtually no lateral displacement of the strands of plastic material, there consequently also being uniform wear of the cutter wheel. At any rate, the zigzag-shaped cutting edge completely cancels out the tendency that exists in the case of continuously inclined cutters for all the strands to be laterally displaced in the same direction, since, if at all, it is only over the relatively short wheel portions that there might be the tendency for a lateral displacement of the strands of plastic material, which, however, as is demonstrated in practice, actually does not occur, because, namely, in consideration of the only small inclination of the cutters, the rise of the cutters in each cutter portion is only by a few millimetres. The need to replace the cutters because of wear is thus substantially reduced, this being of considerable economic significance in view of the usually continuous mode of operation in the granulation of strands of plastic material.

The direction of the zigzag-shaped cutting edge in its overall longitudinal direction may be parallel to the axial direction. Alternatively, however, it is possible for said overall longitudinal direction to extend at an inclined angle to the axial direction. In the former case, this simplifies the manufacture of the individual wheel portions, while, in the latter case, although the wheel portions are slightly different in design, there is, with regard to the axially extending counter-cutter, such a timing of the cutting operation along a continuous cutting edge that the impact of the cutters on the strands to be cut is laterally staggered, this ensuring the correspondingly smooth running of the cutter wheel.

The zigzag-shaped design of the cutting edge can also be accomplished in that individual adjacent cutter portions have the same inclination. This results, to a certain extent, in an elongated zigzag shape in which some or all of the zigzag lines are each formed by a plurality of cutter portions. This may be advantageous for reasons of the manufacture of the individual cutter portions.

Illustrative embodiments of the invention are presented in the drawings, in which:

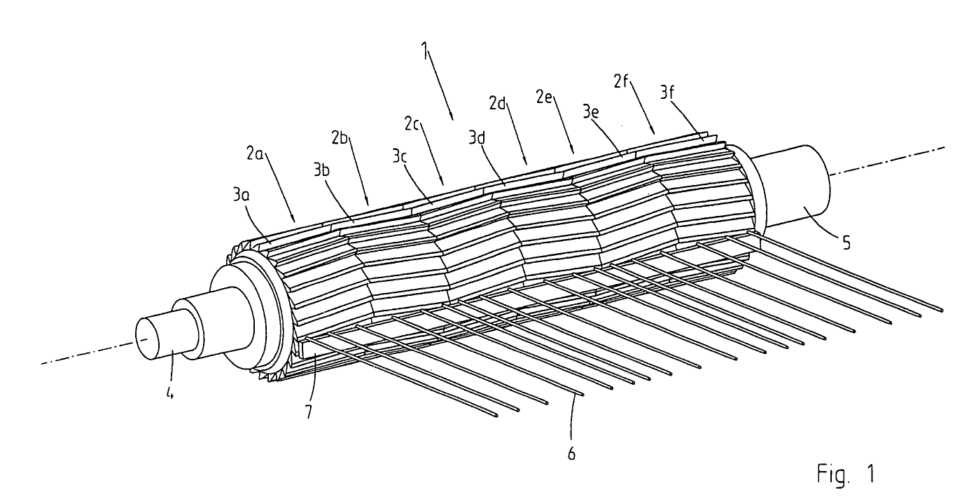

FIG. 1 shows a cutter wheel with zigzag-shaped cutting edge, the overall longitudinal direction of said cutting edge extending parallel to the axial direction;

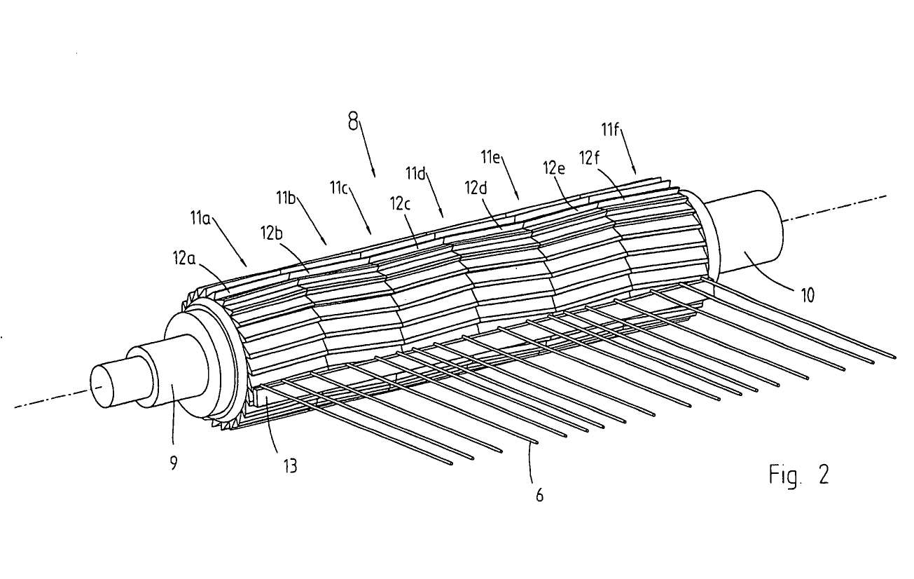

FIG. 2 shows a cutter wheel with zigzag-shaped cutting edge, the overall longitudinal direction of said cutting edge extending at an inclined angle to the axial direction;

FIG. 3 shows a cutter wheel in which individual adjacent cutter portions have the same inclination.

The cutter wheel 1 presented in FIG. 1 is composed of the jointlessly juxtaposed wheel portions 2a-2f, each of which has the cutter portions 3a-3f. Because of the juxtaposition of the wheel portions 2a-2f, said cutter portions 3a-3f are so arranged that, over the entire cutter wheel 1, there is a continuously extending zigzag-shaped cutting edge. The overall longitudinal direction of said individual cutting edges formed by the cutter portions 3a-3f extends parallel to the axial direction of the cutter wheel 1. Said axial direction is symbolized by the dash-dotted line at either end of the cutter wheel 1. Projecting out of the cutter wheel at said ends are the axle journals 4 and 5, which are provided in known manner for supporting and driving the cutter wheel.

The cutter wheel 1 is supplied in known manner via the counter-cutter 7 with the individual strands of plastic material 6, said counter-cutter 7 extending up close to the individual cutter portions 3a-3f, with the result that, upon rotation of the cutter wheel 1, the strands 6 supplied via the counter-cutter 7 are cut into granules.

Owing to the small inclination of each of the individual cutter portions 3a-3f, the supplied strands 6 are subjected to the initially mentioned small displacement force in the axial direction, with the consequence that they are slightly crowded together towards that point at which the respective cutter first strikes the counter-cutter 7 as the cutter wheel 1 rotates. Because of the zigzag-shaped arrangement of the cutter portions 3a-3f, there is, with respect to adjacent wheel portions 2a-2f, a displacement force in the opposite direction, with the result that, in each wheel portion, there is only a very small displacement and therefore practically a uniform loading of the overall cutter wheel 1.

In the cutter wheel presented in FIG. 1, the cutting points, which all lie at the same rotation angle of the cutter wheel 1 in the axial direction thereof, always strike the issuing strands of plastic material 6 simultaneously, this not having any considerable adverse effect on the smooth running of the cutter wheel on account of the fact that the respective strands are distributed over the entire cutter wheel. However, this effect can be eliminated by means of a design as presented in FIG. 2, where the cutter wheel 8, which is supported by the two axle journals 9 and 10, is provided, similarly to the cutter wheel 1 presented in FIG. 1, with a total of six individual wheel portions 11a-f, the cutter portions 12a-12f of which extend in zigzag manner with respect to each other, it being the case, however, that the continuous cutting edges formed by the cutter portions 12a-12f are at a slight inclination with respect to the axis of the cutter wheel. The consequence thereof is that, as the cutter wheel 8 rotates, the timing of the impacting of the continuous cutting edges on the counter-cutter 13 is staggered, this being beneficial for the smooth running of the cutter wheel 8.

FIG. 3 presents a variation on the design of the cutter wheel 1 according to FIG. 1. In FIG. 3, the cutter wheel 14 is provided with individual wheel portions 15a and 15b as well as 16a and 16b in which the cutter portions 17a and 17b as well as 18a and 18b have the same direction of inclination, this resulting practically in a more elongated zigzag, which is of advantage for reasons of the manufacture of the cutter portions and stockkeeping thereof. In principle, however, also in the case of the design of the cutter wheel 14 as presented in FIG. 3, there is a zigzag shape with the effect that there is only a very slight degree of crowding-together of the strands of plastic material 6 as they are being cut.

1-4. (canceled)

5. Cutter wheel (1, 8, 14) for granulating strands of plastic material (6), said cutter wheel (1, 8, 14) being composed of a plurality of jointlessly juxtaposed wheel portions (2a-2f; 11a-11f; 15a, b, 16a, b) with individual cutter portions (3a-3f; 12a-12f; 17a, b; 18a, b) and having axially extending teeth, said teeth forming a continuous cutting edge, characterized in that the teeth of the cutter portions (3a-3f; 12a-12f; 17a, b; 18a, b) merge into each other and have such an alternating inclination with respect to the axis of the cutter wheel (1, 8, 14) that there result a plurality of pairs of cutter portions (3a-3b, 3c-3d, 3e-3f; 12a-12b, 12c-12d, 12e-12f) each with alternating inclination of the teeth, said teeth extending over the entire cutter wheel (1, 8, 14) in the form of a continuously extending, multiply zigzag-shaped cutting edge.

6. Cutter wheel according to claim 5, characterized in that the overall longitudinal direction of the zigzag-shaped cutting edge extends parallel to the axial direction.

7. Cutter wheel according to claim 5, characterized in that the overall longitudinal direction of the zigzag-shaped cutting edge extends at an inclined angle to the axial direction.

8. Cutter wheel according to claim 5, characterized in that individual adjacent cutter portions (17a, 17b; 18a, 18b) have the same inclination.
